(19) United States
(12) Patent Application Publication
(10) Pub. No.: US 2004/0047630 A1
(43) Pub. Date: Mar. 11, 2004

(54) Optical broadband transmission device and distribution method

(76) Inventors: Robert Furst, Freising (DE); Gustav Muller, Osterhofen (DE); Olaf Schonfeld, Munchen (DE)

Correspondence Address: JENKINS & WILSON, PA, 3100 TOWER BLVD, SUITE 1400, DURHAM, NC, 27707, US

(21) Appl. No.: 10/458,646

(22) Filed: Jun. 10, 2003

Related U.S. Application Data
(63) Continuation of application No. PCT/EP01/14941, filed on Dec. 18, 2001.

(30) Foreign Application Priority Data
Jan. 18, 2001 (DE) 10102144.5

(51) Int. Cl. H04J 14/02; H04B 10/12; H04B 10/24

(52) U.S. Cl. 398/42; 398/139; 398/142

(57) ABSTRACT

An optical broadband transmission device for the broadband transmission of data streams between a supply node and a user node. The device comprises an optical fiber for the broadband transmission of data streams between the fiber node and the user node, and a first optical transceiver to the supply node and to the first end of the optical fiber. A second transceiver is connected to the user node and to the second end of the optical fiber. The first and second optical transceiver are designed for transmitting and receiving, respectively, data streams on different optical carrier wavelengths via the optical fiber.

The present invention relates to an optical broadband transmission device for a high-bit-rate data transmission, particularly also of multimedia contents, from a supply node to a user node as claimed in the preamble of claim 1 as known from WO 00/74278 A1.

According to the prior art, digital data streams are transmitted to a user, for example, by means of so-called ATM (asynchronous transfer mode) protocols. The increasing demand for the transmission to a user of multimedia content in addition to voice data requires transmission media with a wide bandwidth. In the literature, numerous methods and devices based on the transmission of data streams via copper or fiberglass lines and by means of complicated protocols are described. By comparison, an Ethernet protocol is a very simple protocol for transmitting multimedia data streams when sufficient bandwidth is provided at the physical level, i.e. in the form of a suitable transmission medium.

In this connection, it is desirable to transmit, in particular, the last part of the transmission link (“the last mile”) by means of an Ethernet protocol and by using single-wire lines, wire bundles or twisted pairs which can be constructed to be shielded or unshielded. Conventional Ethernet data transmissions are based on point-to-multipoint and point-to-point data transmissions. In principle, adding voice transmission capabilities has hitherto been carried out in two different ways:

(a) adding a specific device to the Ethernet in order to provide for conventional ISDN (integrated services digital network) telephony devices and POTS (plain old telephone system) telephony devices. This principle is usually called a LAN (local area network) telephone; and

(b) allocating particular frequency bands to voice data on a copper line.

The devices and methods relating to point (b) are described in U.S. Pat. No. 6,088,368 and known by the name 10BaseS. The 10BaseS method provides a transmission rate of 10 Mbs (megabit per second) over a maximum length of 1200 m. Further existing methods are designated in the first column of the table below and their characteristics such as transmission rate, cable type, maximum length and connecting device are in each case designated in columns 2 to 5.

TABLE

| | Transmis- | | Maximum | Connecting |
|---|---|---|---|---|
| Designation | sion rate | Cable type | length | device |
| 10BaseT | 10 Mbs | UTP | 100 m | RJ-45 |
| 10Broad36 | 10 Mbs | Coax | 1800 m | |
| 10BaseFL | 10 Mbs | 2 × MMF, | 2000 m | ST |
| | | 850 nm | | |
| 10BaseS | 10 Mbs | UTP | 1200 m | RJ-45 |
| 100BaseTX | 100 Mbs | 2 × UTP, | 100 m | RJ-45 |
| | | cat. 5 | | |
| 100BaseFX | 100 Mbs | 2 × MMF, | 2000 m | SC |
| | | 1300 nm | | |
| 100BaseT4 | 100 Mbs | 4 × UTP, | 100 m | RJ-45 |
| | | cat. 3 | | |
| 100BaseS | 100 Mbs | 4 × UTP, | 430 m | |
| | | cat. | | |
| 1000BaseLX | 1000 Mbs | 2 × MMF, | 550 m | SC |
| | | 1300 nm | | |
| | | 2 × SMF, | 5000 m | SC |
| | | 1300 nm | | |
| 1000BaseSX | 1000 Mbs | 2 × MMF | 275 m | SC |
| | | 62.5/125,850 | | |
| | | 2 MMF, | 550 m | SC |
| | | 50/125, | | |
| | | 850 nm | | |
| 1000BaseCX | 1000 Mbs | twinax | 25 m | HSSC |

Single unshielded twisted pairs (UTP), i.e. those implemented once, are generally known and are widely used for connecting a terminal of a user. As can be seen from the above table, however, the transmission rate is no more than 10 Mbs. However, this transmission rate of 10 Mbs provided in accordance with the 10BaseS method and used in conventional devices is not sufficient by far for transmitting simultaneously an MPEG-2 video data stream, a voice data stream and an acceptable user data stream. Higher transmission bandwidths would allow telecommunication devices to provide video data, voice data and user data streams on the basis of single sources for, for example, residential areas, particularly multi-dwelling units or office units as long as the line lengths are sufficient, i.e. typically at last 500 to 1000 m.

Furthermore, optical fibers and optical components are used in optical transmission technology in a familiar manner. The use of optical glass fibers in areas of sensors and particularly in optical communication technology for transmitting data streams is known from “Wolfgang Bludau, Lichtwellenleiter in Sensorik und optischer Nachrichtentechnik”, [optical waveguides in sensors and optical communication technology], Springer Verlag, ISBN 3-540-63848-2 (1998). Optical waveguiding forms the basic concept of optical transmission technology in this case and, in particular, the difference between step-index and gradient-index glass fibers should be pointed out.

On page 33 of the Springer publication, semiconductor materials, glass, polymers and lithium niobate are mentioned as substrate materials, i.e. as materials which are used as a starting basis for the production of optical waveguides (optical fibers or briefly fibers). Similarly, the difference between the ray-optical light propagation in an optical fiber provided with a step-index profile and with a parabolic profile is illustrated on page 45 (FIG. 3.7 of the disclosure).

Conventional optical receivers and transmitters are described, for example, in the publication “Optics, Optoelectronics and Photonics Engineering Principals and Applications by Allan Billings, Prentice Hall, ISBN 0-13-709115-X (1993)”.

A method to transmit data streams with a bandwidth of 100 Mbs is called 100BaseS and can be found in row 8 in the above table. As can be seen from the table, the device and the method of the “100BaseS” needs four unshielded twisted pairs which are usually not provided in target areas which essentially comprise residential areas or MDUs (multi dwelling units) to be networked.

In addition, the device and the method of the “100BaseS” have the disadvantage that the achievable line lengths are not sufficient.

FIG. 5 shows a known device for transmitting data streams between a supply node 104 and a user node 105 via an electrical transmission line 501, a first connecting device 106 being used for connecting the supply node 104 to a first node connection 112 and a second connecting device 107 being used for connecting the user node 105 by means of a second node connection 113.

These conventional devices for transmitting data streams via the electrical transmission line 501 which, for example, use one of the cable types shown in the above table have the disadvantage, among other things, that only small data streams can be transmitted.

A further disadvantage of transmission devices according to the prior art consists in that only short distances can be bridged which are not suitable for use, for example, in multi-dwelling units (MDUs).

Another disadvantage of transmission devices according to the prior art consists in that preferred transmission protocols such as, e.g. 100BaseT Fast Ethernet protocols cannot be used since bandwidths of conventional transmission devices, i.e. of the physical layer or, respectively of the transmission medium are not adequate.

It is thus an object of the present invention to provide for data streams with a wide bandwidth from one or more supply nodes to one or more user nodes and, at the same time, to bridge transmission path lengths which are sufficient for being able to supply multi-dwelling units (MDUs) or office units with data streams.

The above objects are achieved by an optical broadband transmission device as claimed in claim 1 and a distribution method for data streams as claimed in claim 12.

The device according to the invention, having the features of claim 1, and the method according to the invention as claimed in claim 12 have the advantage that data streams with a high data rate can be transmitted.

A further advantage of the device according to the invention and of the method according to the invention consists in that an efficient transmission medium can be used without having to have recourse to complex transmission structures or mediums.

The core of the invention is a device and a method for broadband transmission of data streams by means of an efficient transmission medium.

According to a preferred development of the present invention, a diode transmitter module has a first optical transmitter diode and a second optical transmitter diode so that data stream transmission is provided at different optical wavelengths.

According to a further preferred development of the present invention, the transmission device according to the invention has electrical and optical components which are capable of transmitting data streams at a transmission rate of 100 Mbs (megabits per second).

According to yet another preferred development of the present invention, a laser transmitter module has a laser transmitter unit which is connected to an optical fiber via a coupling unit in order to provide one or more wavelengths for a data stream transmission, wherein long transmission lengths can be achieved.

According to a further preferred development of the present invention, building equipment is provided with a LAN (local area network) switching device or LAN switch, respectively, which makes it possible to transmit a data stream from a router device to first and second LAN modem devices.

According to another preferred development of the present invention, bidirectional transmission of data streams is provided.

According to another preferred development of the present invention, the optical fiber for transmitting data streams is a single plastic optical fiber (POF).

According to another preferred development of the present invention, the optical fiber for transmitting data streams is a step-index fiber.

According to another preferred development of the present invention, the optical fiber for transmitting data streams is a gradient-index fiber.

Exemplary embodiments of the invention are shown in the drawings and explained in greater detail in the description following.

In the drawings:

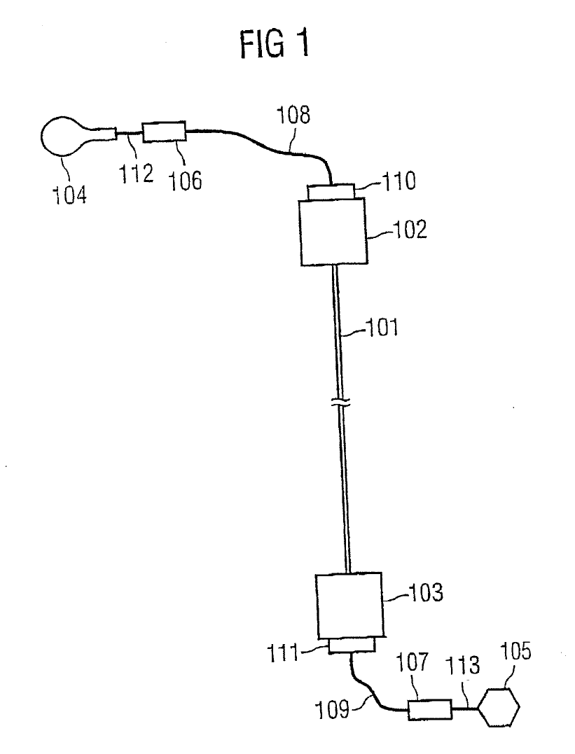

FIG. 1 shows a device for transmitting data streams by means of an optical fiber between a first optical transceiver and a second optical transceiver according to an exemplary embodiment of the present invention;

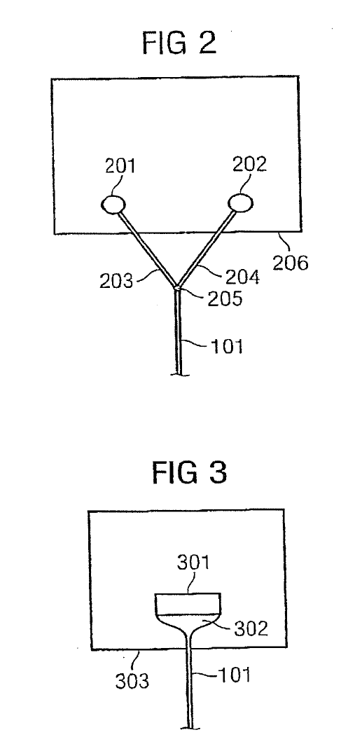

FIG. 2 shows an exemplary embodiment of a diode transmitter module for transmitting data streams arriving at a supply node, shown in FIG. 1, by means of a first optical transmitter diode and a second optical transmitter diode according to an exemplary embodiment of the present invention;

FIG. 3 shows a laser transmitter module which contains a laser transmitter unit and a coupling unit, for transmitting data streams according to an exemplary embodiment of the present invention;

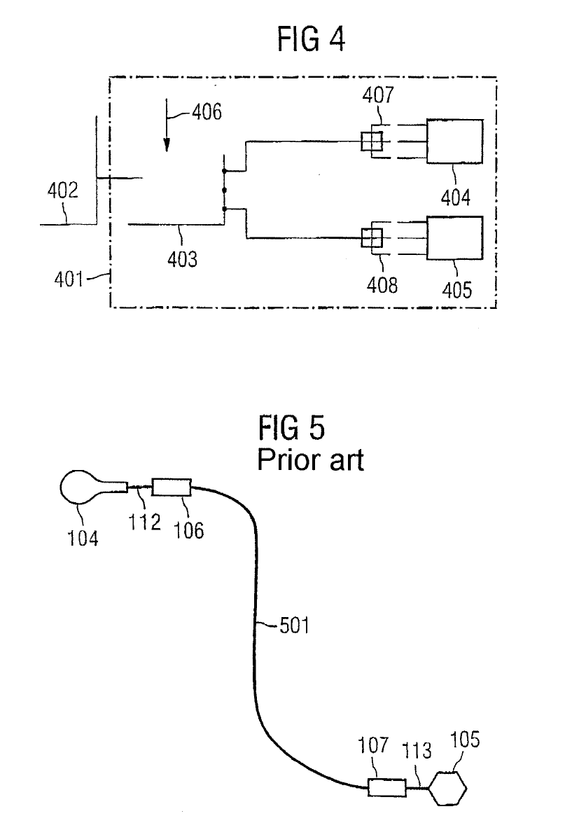

FIG. 4 diagrammatically shows a representation of building equipment which illustrates how data streams are supplied to first and second LAN modem devices from a router device via a LAN switch; and

FIG. 5 shows a conventional device for transmitting data streams.

In the figures, identical reference symbols designate identical or functionally identical components.

FIG. 1 shows a device for transmitting data streams by means of an optical fiber 101 between a first optical transceiver 102 and a second optical transceiver 103 according to an exemplary embodiment of the present invention.

The device shown in FIG. 1 has as the central element an optical fiber 101 which connects a first optical transceiver 102 to a second optical transceiver 103. This device can be used for transmitting data streams between a supply node 104 and a user node 105 with much greater bandwidth than is possible with a wire-connected transmission medium according to the prior art. The transmission rate according to the method is typically 100 Mbs whereas, according to the prior art, a maximum of 10 Mbs are provided with an electrical transmission line with the same transmission length (500 to 1000 m). Referring to FIG. 1, the first supply node 104 is connected to a first connecting device 106 via a first node connection 112 which is constructed as electrical connection (plug connection). The output of the first connecting device 106 is (electrically) connected via a first line connection to a first processing circuit 110, the first line connection 108 only being used for connecting the first connecting device 106 and, therefore, is constructed to have a correspondingly short line length. The first processing circuit 110 processes the signal supplied via the first line connection 108, i.e. the data stream, and supplies the processed signal to the first optical transceiver 102. The first optical transceiver 102 is coupled to the optical fiber 101 in such a manner that data streams can be sent both to the optical fiber 101 and data streams can be received from the optical fiber 101, i.e. a bidirectional operating mode is provided. Exemplary embodiments for transmitting optical data streams to the optical fiber 101 are given in the subsequent description, referring to FIGS. 2 and 3.

A second optical transceiver 103 is connected to a second end of the optical fiber 101. Similarly to the first optical transceiver 102, the data streams into the second optical transceiver 102 are converted from an optical data stream into an electrical data stream or conversely. An output signal of the second optical transceiver 103 is supplied to a second processing circuit 111 which supplies a processed data stream as an electrical signal to a second connecting device 107 via a second line connection 109. The second connecting device 107 is connected to the user node 105 via a second node connection 113 from which the data streams are distributed further as will be explained below by means an exemplary embodiment, referring to FIG. 4.

It should be pointed out that, according to the exemplary embodiment of the present invention described above, the first connecting device 106, the first line connection 108, the first processing circuit 110 and the first optical transceiver 102 can be provided in a first common plug housing in the optical broadband transmission device, in order to ensure compatibility with existing connecting devices according to the prior art to a supply node 104.

Furthermore, the second connecting device 107, the second line connection 109, the second processing circuit 111 and the second optical transceiver 103 can be provided in a first common plug housing in the optical broadband transmission device in the exemplary embodiment of the present invention described above, in order to ensure compatibility with existing connecting devices according to the prior art to a user node 105.

FIG. 2 illustrates an exemplary embodiment of a diode transmitter module 206 for transmitting data streams arriving at a supply node 104, shown in FIG. 1, by means of a first optical transmitter diode 201 and a second optical transmitter diode 202 according to an exemplary embodiment of the present invention.

In the device shown in FIG. 2, a diode transmitter module 206 consists of a first optical transmitter diode 201 and a second optical transmitter diode 202 which sends out radiations of different wavelengths, for example in the red and green spectral band. The optical radiation of the from the [sic] first optical transmitter diode 201 and the optical radiation of the second optical transmitter diode 202 is in each case supplied to a first optical fiber branch 203 and, respectively, a second optical fiber branch 204. The two optical fiber branches 203 and 204 are combined in a fiber branch device 205 and are optically connected to the optical fiber 101. The device according to FIG. 2, shown in the exemplary embodiment of the present invention, makes it possible to transmit data streams on different carriers, in this case different wavelengths.

It should be pointed out that the diode transmitter module 206 shown in FIG. 2 is constructed as diode receiver module at the receiving end and the first and second optical transmitter diodes 201 and 202, respectively, have to be replaced by first and second optical receiver diodes.

Furthermore, the first and second optical transceivers 102 and 103, respectively, can be formed of in each case a combination of a diode transmitter module 206 with a diode receiver module, the first and second processing circuits 110 and 11 being correspondingly modified.

FIG. 3 shows a laser transmitter module 303 which contains a laser transmitter unit 301 and a coupling unit 302, for transmitting data streams according to an exemplary embodiment of the present invention.

In the exemplary embodiment, shown in FIG. 3, of the present invention, a laser transmitter module 303 consists of a laser transmitter unit 301 and a coupling unit 302. In distinction from the device shown in FIG. 2, the device shown in FIG. 3 has the advantage that one or more wavelengths can be emitted by means of the laser transmitter unit 301 with a high spectral power density so that, on the one hand, long transmission lengths can be bridged via the optical fiber 101 and, on the other hand, data streams can be transmitted on one or more carriers in accordance with one or more wavelengths.

The laser transmitter module 303 shown in FIG. 3 can be used instead of the diode transmitter module 206, shown in FIG. 2, but a corresponding laser receiver module must be provided for receiving the respective data streams as explained with reference to FIGS. 1 and 2.

FIG. 4 diagrammatically shows a representation of building equipment 401 which illustrates how data streams are supplied to first and second LAN modem devices 404 and 405, respectively, from a router device 402 via a LAN switch 403.

In the exemplary embodiment shown in FIG. 4, the dashed line represents building equipment 401. The building equipment 401 contains a LAN (local area network) switch 403 which forwards data streams to a first LAN modem device 404 and second LAN modem device 405. At the LAN switch 403, video data 406 can be supplied. The building equipment 401 is connected to a router device 402, building equipment for, for example, multi-dwelling units (MDUs) or office units being provided according to the exemplary embodiment of the present invention.

The present embodiments of the invention thus provide a device and a method for the inexpensive transmission of data streams with a high bit rate between a supply node 104 and a user node 105.

In particular, the optical fiber 101 can be designed as a plastic optical fiber (POF) which provides for further cost reduction. This enables the fiber branch device 205 to be dispensed with and both signals can be injected or one can be extracted and one can be injected.

The connection between the first optical transceiver 102 and the second optical transceiver 103 has a transmission length of typically 500 to 1000 m so that an optical access to building equipment can be set up by means of inexpensive plastic optical fibers.

The optical transceivers can also be manufactured inexpensively since no long transmission lengths need to be bridged. In this arrangement, a first LAN modem device is connected via a first intermediate access device 407 and the second LAN modem device 405 is connected via a second intermediate access device 408, in each case to the LAN switch 403.

Increasing building networking, particularly in multi-dwelling units and office unit [sic] or business spaces, building automation and advances in building system technology lead one to expect that the device according to the invention and the method according to the invention will find increasing application possibilities.

Although the present invention was described above by means of preferred exemplary embodiments, it is not restricted to these but can be modified in many ways.

List of reference designations

| | |
|---|---|
| 101 | Optical fiber |
| 102 | First optical transceiver |
| 103 | Second optical transceiver |
| 104 | Supply node |
| 105 | User node |
| 106 | First connecting device |
| 107 | Second connecting device |
| 108 | First line connection |
| 109 | Second line connection |
| 110 | First processing circuit |
| 111 | Second processing circuit |
| 112 | First node connection |
| 113 | Second node connection |
| 201 | First optical transmitter diode |
| 202 | Second optical transmitter diode |
| 203 | First optical fiber branch |
| 204 | Second optical fiber branch |
| 205 | Fiber branching device |
| 206 | Diode transmitter module |
| 301 | Laser transmitter unit |
| 302 | Coupling unit |
| 303 | Laser transmitter module |
| 401 | Building equipment |
| 402 | Router device |
| 403 | LAN switch |
| 404 | First LAN modem device |
| 405 | Second LAN modem device |
| 406 | Video data |
| 407 | First intermediate access device |
| 408 | Second intermediate access device |
| 501 | Electrical transmission line |
| MDU | Multi-dwelling unit |
| POF | Plastic optical fiber |
| UTP | Unshielded twisted pair |

1. An optical broadband transmission device for the broadband transmission of data streams between a supply node (104) and a user node (105), comprising:
an optical fiber (101) for the broadband transmission of data streams between the supply node (104) and the user node (105);
a first optical transceiver (102) which is connected to the supply node (104) and to a first end of the optical fiber (101);
a second optical transceiver (103) which is connected to the user node (105) and to a second end of the optical fiber (101);
characterized in that the first and second optical transceiver (102, 103) are designed for transmitting and receiving, respectively, data streams on different optical carrier wavelengths via the optical fiber (101).

2. The optical broadband transmission device as claimed in claim 1, characterized in that the optical fiber (101) is a plastic optical fiber.

3. The optical broadband transmission device as claimed in one of claims 1 and 2, characterized in that the supply node (104) is connected via a first node connection (112) to a first connecting device (106) which is connected to a first processing circuit (110) of the first optical transceiver (102) via a first line connection (108).

4. The optical broadband transmission device as claimed in one of claims 1 to 3, characterized in that the user node (105) is connected via a second node connection (113) to a second connecting device (107) which is connected to a second processing circuit (111) of the second optical transceiver (103) via second line connection (109).

5. The optical broadband transmission device as claimed in claim 3, characterized in that the first connecting device (106), the first line connection (108), the first processing circuit (110) and the first optical transceiver (102) are accommodated in a first common plug housing.

6. The optical broadband transmission device as claimed in claim 4, characterized in that the second connecting device (107), the second line connection (109), the second processing circuit (111) and the second optical transceiver (103) are accommodated in a first common plug housing.

7. The optical broadband transmission device as claimed in one of the preceding claims, characterized in that the first and/or second optical transceiver (102, 103) has a diode transmitter module (206) comprising a first optical transmitter diode (201) and a second optical transmitter diode (202).

8. The optical broadband transmission device as claimed in one of the preceding claims, characterized in that the first and/or second optical transceiver (102, 103) has a diode receiver module (206) comprising a first optical receiver diode (201) and a second optical receiver diode (202).

9. The optical broadband transmission device as claimed in one of claims 1 to 6, characterized in that the first and/or second optical transceiver (102, 103) has a laser transmitter module (303) with a laser transmitter unit (301) which is connected to the optical fiber (101) via a coupling unit (302).

10. The optical broadband transmission device as claimed in one of claims 1 to 6 and 9, characterized in that the first and/or second optical transceiver (102, 103) has a laser receiver module (303) with a laser receiver unit (301) which is connected to the optical fiber (101) via a coupling unit (302).

11. The optical broadband transmission device as claimed in one of the preceding claims, characterized in that the electrical and optical components are designed for transmitting data streams at a transmission rate of 100 Mbs (megabits per second).

12. The optical broadband transmission device as claimed in one of claims 1 to 11, characterized in that the data streams can be distributed from the user node (105) to building equipment (401) comprising a LAN (local area network) switch (403) which makes it possible to transmit a data stream from a router device (402) to a first and second LAN modem device (404, 405).

13. The optical broadband transmission device as claimed in one of claims 1 to 12, characterized in that the optical fiber (101) for transmitting data streams is constructed as a step-index fiber or as a gradient-index fiber.

14. The optical broadband transmission device as claimed in one of claims 1 to 13, characterized in that the data streams can be transmitted bidirectionally.
